(19) United States
(12) Patent Application Publication
(10) Pub. No.: US 2024/0344740 A1
(43) Pub. Date: Oct. 17, 2024

(54) Stabilization of Salts in High-Temperature Nitrate Salt Systems

(71) Applicant: DEUTSCHES ZENTRUM FÜR LUFT - UND RAUMFAHRT E.V., Bonn (DE)

(72) Inventors: Freerk KLASING, Bergisch Gladbach (DE); Veronika SÖTZ, Cologne (DE)

(21) Appl. No.: 18/701,087

(22) PCT Filed: Oct. 21, 2022
(86) PCT No.: PCT/EP2022/079432

§ 371 Date: Apr. 12, 2024

(30) Foreign Application Priority Data
Oct. 22, 2021 (DE) 10 2021 127 566.0

(51) Int. Cl. F24S 80/20; F24S 10/00; F24S 60/30

(52) U.S. Cl. CPC F24S 80/20; F24S 60/30; F24S 10/00

(57) ABSTRACT

The invention relates to a method for thermally stabilizing molten nitrate salt in thermal power plants, in particular solar power plants, having the steps of: a) providing molten nitrate salt, said nitrate salt being selected from alkali metal nitrates, alkaline earth metal nitrates, and mixtures of one or more alkali metal nitrates and alkaline earth metal nitrates, and transporting the molten nitrate salt in lines provided for this purpose and b) introducing a heat quantity ΔQₚₐₜ into the molten salt at a defined position, wherein the heat quantity is provided in particular by means of solar energy. The invention is characterized in that prior to or after step b), a stabilization gas is supplied to the molten nitrate salt, said stabilization gas having oxygen, at least one nitric gas, and optionally nitrogen. The invention also relates to a device for carrying out the method.

### FIELD OF THE INVENTION

The present invention relates to a method for the thermal stabilization of nitrate salt melts by means of a stabilization gas, the stabilization gas containing oxygen, at least one nitrogen oxide and optionally nitrogen. Furthermore, the present invention relates to a device for carrying out the method according to the invention.

### BACKGROUND OF THE INVENTION

In solar thermal energy generation, molten salts are used to store and transport the absorbed solar heat. The prior art includes the use of nitrate salt melts (alkali metal nitrates, alkaline earth metal nitrates, and mixtures of alkali metal nitrates and alkaline earth metal nitrates) in corresponding high-temperature systems for heat transfer and/or for heat storage. The nitrate salt or the mixture of nitrate salts is used at temperatures above the respective melting point in order to maintain their fluidity. The molten salt is heated by solar heat supply and then contains thermal energy, which is transported with the molten salt to other parts of the system (the solar thermal power plant) and used and/or stored there. According to the prior art, the salt is heated up to a maximum temperature (thermal stability limit), which is individual for the respective salt or the respective mixture of salts. For example, for a mixture of 60% by weight sodium nitrate and 40% by weight potassium nitrate, it is 565° C. The main reason for this is the thermal decomposition of the molten salt at higher temperatures, which adversely affects material properties and produces environmentally harmful gases.

The use of nitrate salt melts in the high-temperature range is specifically described below using the example of solar tower power plants with molten salt energy storage. This power plant technology with integrated energy storage has been in commercial operation for a number of years on a 100 MW scale. In solar tower power plants, a molten salt consisting of 60% by weight of sodium nitrate and 40% by weight of potassium nitrate is usually heated to about 565° C. by concentrated solar radiation. The heated salt then flows into an insulated tank for temporary storage. Hot molten salt from the storage tank, in turn, flows into a power generation component where the thermal energy contained in the molten salt is converted to electric power. The integration of the storage unit also enables electricity to be produced at night and when it is cloudy.

A more effective use of solar energy would be possible by increasing the temperature. However, this is not possible with the usual material systems and operating conditions. The reason for this is decomposition processes and material instability of the nitrate salt melts, which accelerate and intensify with increasing temperatures. At temperatures above the thermal stability limit, formation of toxic gases and corrosive ions and compounds can be expected. Ultimately, this can be expected to result in a reduced storage lifespan and the need to install additional safety components. Both have a negative effect on the profitability of the nitrate salt systems and thus of the solar power plants as a whole.

There is therefore a need for stabilization of the nitrate salt melts so that the formation of corrosive or toxic compounds is prevented as far as possible or at least significantly reduced.

### BRIEF DESCRIPTION OF THE DRAWINGS

The present invention is illustrated and described herein with reference to the various drawings, in which like reference numbers denote like method steps and/or system components, respectively, and in which:

FIG. 1 is a schematic diagram illustrating basic structure of a solar receiver

FIG. 2 is schematic diagram of one embodiment of the method for the thermal stabilization of nitrate salt melts in thermal power plants;

FIG. 3 is schematic diagram of another embodiment of the method for the thermal stabilization of nitrate salt melts in thermal power plants; and

FIG. 4 is schematic diagram of another embodiment of the method for the thermal stabilization of nitrate salt melts in thermal power plants.

### DETAILED DESCRIPTION OF THE INVENTION

Surprisingly, it has been shown that thermal stability of nitrate salt melts can be enabled by stabilizing gases. Stabilizing gases allow working with known nitrate salt melts at temperatures that are higher than those currently employed without reducing the service life of the power plants, in particular solar power plants, due to the increased corrosiveness of the molten salts. In a first embodiment, the object of the present invention is achieved by a method for stabilizing nitrate salt melts in thermal power plants, in particular solar power plants, comprising:
a) providing a nitrate salt melt, the nitrate salt being selected from alkali metal nitrates, alkaline earth metal nitrates and mixtures of one or several alkali metal nitrates and alkaline earth metal nitrates, and transporting the nitrate salt melt in conduits provided for this purpose,
b) introducing a quantity of heat ΔQₚₐₜ to the melt at a defined position, the quantity of heat being provided in particular by means of solar energy,
characterized in that upstream of and before, at the same time as, or downstream of and after step b), a stabilizing gas is fed to the nitrate salt melt, the stabilizing gas comprising oxygen, at least one nitrogen oxide and optionally nitrogen.

According to the invention, the nitrate salt melt is provided in conduits in a power plant, in particular a solar power plant, and is used there to absorb and transport and possibly store the heat, which is transferred from the sun to the melt directly or indirectly, for example. The molten salt (nitrate salt melt, melt) is transported in conduits and, if necessary, stored in tanks. By supplying a quantity of heat, the melt is further heated—even beyond the thermal stability limit of the melt. Said thermal stability limit is the temperature above which the molten salt decomposes under the current normal operating conditions. The thermal stability limit of solar salt, for example, is 565° C.

Usually, the amount of heat is supplied locally at a defined position. This can lead to decomposition of the salt melt locally at this point, which affects the process in the power plant as a whole, since decomposition products are produced and the melt is no longer fully available for transporting or storing the heat. In particular, the formation of gaseous decomposition products can lead to oversaturation of the gas in the melt and thus to the formation of gas bubbles. These gas bubbles are disadvantageous, however, since they impede the transfer of heat during the introduction of heat.

In principle, it is also possible to supply the amount of heat to the nitrate salt melt in partial amounts of heat. Here the decomposition of the melt is to be expected only in the hotter zone. Accordingly, the zone in which gas bubbles can form is reduced.

However, in both cases, both when the amount of heat is supplied to the system at once and when the heat is divided into partial amounts, there is a need for a process which avoids or at least reduces the known disadvantages which result from the decomposition of the nitrate salt melt.

Surprisingly, it has been shown that the thermal stability of nitrate salt melts is improved by supplying a stabilizing gas at any temperatures and, in particular, also at temperatures above the provided maximum temperatures (thermal stability limit) of the respective nitrate salts.

In a further embodiment, the object of the present invention is achieved by a device for carrying out the method described above, the device comprising the following components:
a) at least one, in particular one, receiving unit for receiving thermal energy, in particular from solar radiation,
b) at least one, in particular one, first storage unit (hot storage) in which a nitrate salt melt can be stored after it has absorbed thermal energy from the receiving unit,
c) at least one, in particular one, consumer in which the thermal energy from the nitrate salt melt is converted into electric power,
d) at least one, in particular one, second storage unit (cold storage) in which the nitrate salt melt can be stored after the thermal energy has been converted into electric power, and
d) circuits in which a nitrate salt melt is circulated, wherein the device further
e) has at least one first subcomponent, in which a stabilizing gas is fed to the nitrate salt melt, wherein the at least one first subcomponent is provided upstream or downstream of the at least one receiving unit for receiving thermal energy in the direction of flow of the nitrate salt melt.

In a preferred embodiment, the device according to the invention further has
f) at least one second subcomponent, in which the stabilizing gas is at least partially recovered from the nitrate salt melt,
wherein the at least one second subcomponent is provided downstream of the at least one first subcomponent and downstream of the at least one receiving unit for receiving thermal energy in the direction of flow of the nitrate salt melt.

In particular, the device is a solar thermal power plant in which the nitrate salt melt is used to absorb, store and/or transport heat. If the position of individual components is described as “upstream” or “downstream” of another component, this is to be understood in terms of the direction of flow of the molten nitrate salt in the power plant.

Preferred embodiments of the method and the device are described in more detail below, with all features being able to be combined with one another in any desired manner and, where relevant, apply to both the method and the device according to the invention.

The method according to the invention provides that a stabilizing gas is supplied to a nitrate salt melt. In the context of the present invention, a “nitrate salt melt” is a melt of one or more alkali metal nitrates and/or alkaline earth metal nitrates or mixtures of one or more alkali metal nitrates and alkaline earth metal nitrates. A “nitrate salt” within the meaning of the present invention may thus be an alkali metal nitrate. It may also be a mixture of 2, 3 or more alkali metal nitrates. The same applies to the alkaline earth metal nitrates. According to the invention, a nitrate salt may also comprise 2, 3 or more alkaline earth metal nitrates. It is also called a “nitrate salt” when it includes mixtures of one or more alkali metal nitrates with one or more alkaline earth metal nitrates. For example, the nitrate salt melt may be a melt of solar salt, which is a mixture of 60% by weight sodium nitrate and 40% by weight potassium nitrate.

Depending on its exact composition, the nitrate salt has a specific melting point above which the nitrate salt is liquid at ambient pressure. If this melting temperature is exceeded, the nitrate salt is liquid and is present as a melt. In this form, it can be transported in a thermal power plant, in particular a solar power plant, and pumped in the conduits provided for this purpose.

According to the invention, the nitrate salt melt is charged with a stabilizing gas in at least a first subcomponent of a power plant. According to the invention, one, two, three or more first subcomponents can be present. More preferably, there are one or two first subcomponents which enable the nitrate salt melt (molten salt) to be charged with the stabilizing gas.

The stabilizing gas is a gas mixture that contains, in particular, oxygen, at least one nitrogen oxide, and optionally nitrogen. More preferably, the stabilizing gas consists of oxygen, at least one nitrogen oxide and nitrogen, and particularly preferably, the stabilizing gas consists of oxygen and at least one nitrogen oxide. Nitrogen oxides within the meaning of the present invention include NO, NO₂ and N₂O, in particular NO and NO₂.

Surprisingly, it has been shown that the stabilizing gas ensures that the nitrate salt melt remains thermally stable. Typically, the nitrate salt melt not only decomposes at temperatures above the thermal stability limit, but also below it. The addition of the stabilizing gases now makes it possible for the nitrate salt melt not to decompose. This allows for more effective and longer operation of a thermal power plant.

It is possible according to the invention for the stabilizing gas to be supplied to the nitrate salt melt before the amount of heat is supplied. This is intended to prevent or at least significantly reduce decomposition of the nitrate salt during the supply of heat.

According to the invention, it is also possible for the stabilizing gas to be supplied only after the amount of heat has been supplied. The stabilizing gas ensures that there is no further decomposition of the nitrate salt melt and that any decomposition products that are present are converted back to a nitrate salt.

In the hottest zone of the heat input of the heat quantity ΔQₚₐₜ (typically in the last zone of a heat exchanger, such as a solar receiver, through which flow occurs), local temperature peaks occur. In order to intercept the resulting decomposition of the molten salt, the stabilizing gas is added according to the invention. The molten salt is usually supersaturated with the stabilizing gas, resulting in a two-phase flow in which the molten salt and the stabilizing gas are present separately from one another.

In one embodiment, it is therefore provided according to the invention that the excess stabilization gas is again separated from the molten salt before it is passed on through the conduits to the storage system or the downstream power plant process. According to the invention, such a separation of the stabilizing gas can take place in at least one second subcomponent. According to the invention, one, two, three or more second subcomponents can be present. A device according to the invention preferably has one or two second subcomponents. Each of the second subcomponents present is provided downstream of a first subcomponent in the direction of flow of the molten salt. For example, it is possible for a first subcomponent to be present first, followed by a second subcomponent, again followed by a first subcomponent, followed by a second subcomponent. According to the invention, it is also possible for two first subcomponents to be present first, followed by two second subcomponents.

According to the invention, it is also possible for the heat input to not only take place at one position. In this preferred embodiment, the heat input takes place in particular in such a way that the total amount of heat ΔQₚₐₜ, which is transported through the molten salt, is divided into at least two, in particular three or more, partial heat amounts ΔQₚₐₜ₁, ΔQₚₐₜ₂, ΔQₚₐₜ₃, etc., and each of the partial amounts of heat is introduced into the molten salt at a different position from one another. According to the invention, this has the advantage that zones in which gas oversaturation with bubble formation is to be expected are kept as low as possible, so that the heat transfer is not inhibited and also that unwanted gas accumulations in the system, which negatively affect operation, do not occur. Since decomposition is only to be expected in the hotter zone, stabilization gases need to be supplied only in this area. Therefore, in this embodiment, the method according to the invention has the steps that a stabilizing gas is supplied to the nitrate salt melt before or after the last introduced partial heat quantity ΔQₚₐₜ₂ or partial heat quantities ΔQₚₐₜ₂, ΔQₚₐₜ₃, etc.

According to the invention, it is possible for the nitrate salt melt to be supersaturated by the stabilizing gas. According to the invention, it is also possible for saturation to occur, since the gas solubility increases with increasing temperature of the molten salt. In a preferred embodiment, the amount of heat ΔQₚₐₜ is therefore not added completely at just one position in the method according to the invention, but in two, three or more partial amounts of heat at several positions, with a stabilizing gas being added to the molten salt between the respective positions. It is also possible according to the invention that one, two or three or more partial amounts of heat are supplied first and the stabilizing gas is added to the molten salt only before the last and/or penultimate supply of the partial amount of heat is added. In particular, the stabilizing gas is added after at least 70%, preferably at least 80%, in particular at least 90% of the total amount of heat has been supplied in the form of partial amounts of heat.

This allows better control of the amount of stabilizing gas added so that only saturation of the nitrate salt melt rather than supersaturation occurs. While there is a two-phase flow in the case of supersaturation, there is only one phase in the case of saturation, namely the molten salt itself.

In particular, in those embodiments in which oversaturation of the molten salt and two phases are present, the excess stabilizing gas is separated from the molten salt. In a preferred embodiment, the method according to the invention therefore provides that the stabilizing gas is at least partially separated from the nitrate salt melt itself and then reused. The thermal decomposition of the nitrate salt melt results in the formation of nitrogen oxides in particular, which are toxic on the one hand and can lead to corrosion of the components of a power plant on the other. According to the invention, such nitrogen oxides are deposited in the zone of the so-called second subcomponent. A corresponding separation can take place due to gravity, so that there is an automatic separation between liquid nitrate salt melt and the gases that form. It is also possible according to the invention that the second subcomponent includes, in particular is, a device for gas separation, such as a cyclone, in particular. According to the invention, more than one, namely two or three or more so-called second subcomponents may also be present.

The number of the first and also the second subcomponents depends on the amount of heat introduced and the complexity of the system. Therefore, preferably, a device according to the invention has one or two so-called first subcomponents and/or one or two so-called second subcomponents.

According to the invention, in particular oxygen and nitrogen oxides, i.e. the stabilizing gas, are used to stabilize the nitrate salt. The nitrate salt is regenerated by supplying the stabilizing gas. During the decomposition of, for example, solar salt, which is a mixture of sodium nitrate and potassium nitrate consisting of 60% by weight sodium nitrate and 40% by weight potassium nitrate, there is an equilibrium between the nitrate salts and the nitrite salts that are formed, and decomposition with oxide formation takes place, wherein the resulting oxides are corrosive, to name just a few examples. In order to reverse or prevent these reactions, the stabilizing gas is supplied and reacts with the nitrate salt melt. The consumption of oxygen is usually up to 80 g of oxygen per kilogram of solar salt. The consumption of nitrogen oxides is up to 40 g NOₓ per kilogram of solar salt.

Solar salt is preferably used as a nitrate salt or in the form of the corresponding melt for the purposes of the present invention. However, it is also possible and included according to the invention that other nitrate salts or salt mixtures, as defined above, are used. With other nitrate salts, too, oxygen and nitrogen oxidees, possibly also nitrogen, are consumed for regeneration. According to the invention, the stabilizing gas therefore preferably has no further components which could react with the nitrate salt.

The stabilizing gas preferably contains at least 20% by volume, in particular 35% by volume or more, preferably at least 50% by volume, preferably 60% by volume or more, particularly preferably at least 70% by volume, more preferably at least 80% by volume, especially preferably 85% by volume or more, particularly preferably 90% by volume or more, and in a particularly preferred embodiment, 95% by volume of oxygen (O₂).

The proportion of nitrogen oxides is at least 500 ppm, preferably at least 2,500 ppm, in particular at least 5,000 ppm, more preferably at least 10,000 ppm, preferably at least 30,000 ppm or 50,000 ppm or more, especially preferably 100,000 ppm or more, based on the total volume of the stabilizing gas.

Thus, the stabilizing gas may consist exclusively of oxygen and nitrogen oxides. In a preferred embodiment, a mixture containing 80% by volume of oxygen and 20% by volume of nitrogen oxides can be used as the stabilizing gas. Alternatively, the stabilizing gas may contain 90% by volume oxygen and 10% by volume nitrogen oxides. Mixtures which contain only oxygen and nitrogen oxides are preferred according to the invention, the proportion of oxygen being in particular 80% by volume to 98% by volume, the remainder being nitrogen oxides.

However, within the meaning of the present invention, it is also included that the stabilizing gas also contains nitrogen, as far as necessary.

The pressure at which the stabilizing gas is supplied to the nitrate salt melt is preferably 1 bar or more, preferably 2 bar or more, more preferably 5 bar or more. The pressure should not exceed 10 bar, since higher pressures cause the material stress in the power plant to be very high locally. The pressure must be at least 1 bar to prevent ambient air from entering the system, and to avoid negative pressure, which could damage components.

The stabilizing gas can preferably be at least partially separated from the nitrate salt melt. As already stated, this is preferably done on at least one second subcomponent. Depending on the temperature in the solar power plant, it is sufficient to feed the stabilizing gas obtained from the nitrate salt melt back into the nitrate salt melt at another point in the power plant, namely in the first subcomponent. In such an embodiment, the stabilizing gas is recovered completely from the nitrate salt melt. According to the invention, however, it is also possible for the stabilizing gas to be recovered only partially from the nitrate salt melt. In this embodiment, the stabilization gas recovered from the nitrate salt melt is provided with additional gas/gas mixture from an external source. In this embodiment, for example, oxygen and nitrogen are provided and mixed with the gas mixture obtained from the nitrate salt melt, so that a stabilization gas according to the invention is obtained therefrom, which is then supplied to the nitrate salt melt in the zone of the first subcomponent.

The stabilization gas can thus be provided in part using an external source. The stabilizing gas can be provided as a whole, i.e., as both oxygen and optionally nitrogen and also nitrogen oxides, and these can then be fed to the nitrate salt melt in the form of a suitable mixture.

In some embodiments, it is particularly preferred according to the invention that the stabilizing gas is at least partially separated from the nitrate salt melt. It is then enriched with the required gases, so that a stabilizing gas with the required mixture is obtained. This mixture of stabilizing gas is then supplied to the nitrate salt melt.

The charging of the nitrate salt melt with stabilizing gas can take place before or after the introduction of heat into the salt melt. The charging with stabilizing gas preferably takes place before the heat is introduced into the molten salt. This reduces subsequent thermal degradation. If the stabilizing gas is applied after the heat input, this brings about a partial, possibly even complete, regeneration of decomposed nitrate salt. When adding partial amounts of heat, the application of stabilizing gas takes place in particular between the introductions of heat and can also take place additionally after the last introduction of heat.

The absorption of the stabilizing gas into the molten salt can be accelerated by increasing the liquid-gas interface, for example by injecting the stabilizing gas into the molten nitrate salt through nozzles, or by turbulent mixing in the first subcomponent. In contrast to the prior art, a gas mixture for salt stabilization is returned locally to the nitrate salt melt in the first subcomponent. This enables effective use of the stabilizing gas at the points in the reactor where thermal decomposition of the nitrate salt melt usually occurs, so that the decomposition of the nitrate salt melt is effectively prevented.

In a preferred embodiment, the stabilizing gas is taken from the nitrate salt melt in the zone of the second subcomponent. It thus serves to separate the stabilization gas from the two-phase system consisting of the liquid nitrate salt melt with dissolved gases and the gas atmosphere. It is particularly preferred if the second subcomponent is provided in the device according to the invention in such a way that there are no longer any pronounced fluid movements. It is also particularly preferred that the stabilization gas be separated off in such a way that there is no pronounced fluid movement of the nitrate salt melt, so that dissolved gases remain in the salt melt and are not separated off.

The second subcomponent thus enables the stabilization gas to be removed and returned to the first subcomponent, so that there is preferably no need, or possibly only a small need, for gases supplied from outside. In addition, the formation of exhaust gases is significantly reduced. In contrast to the prior art, the gases formed in the nitrate salt melt are specifically removed in the second subcomponent and reused in the same system for the purpose of stabilization.

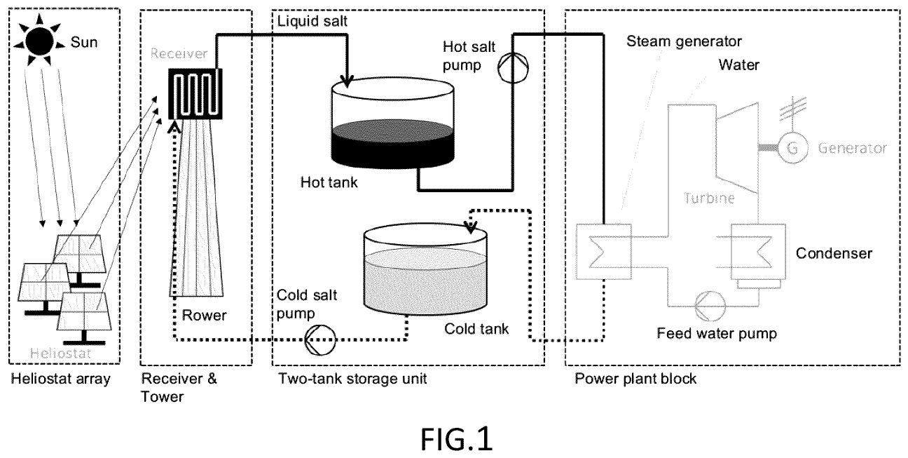

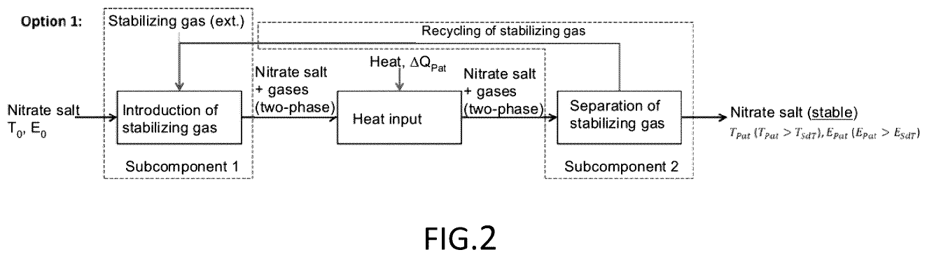

In principle, several different types of process management are possible, as already explained above. This also results in differences in the precise configuration of devices in which the method can be carried out according to the invention. In all of the embodiments, the stabilizing gas is introduced locally, as a result of which the targeted introduction of stabilizing gas either suppresses the decomposition process of the nitrate salt or regenerates the nitrate salt that has been temporarily decomposed. Three possible and preferred configurations are explained below and schematically shown in FIGS. 1 to 4. The basic structure of a solar receiver is shown in FIG. 1, and the components shown for carrying out the method according to the invention are illustrated in FIGS. 2, 3 and 4.

FIG. 1 shows a usual set-up of a known solar receiver in a solar thermal power plant within the meaning of the present invention. This consists of a heliostat array, a tower with a receiver, the two-tank liquid salt storage facility, and a power plant block. Direct solar radiation is concentrated on the receiver by the heliostats and converted there to heat at high temperatures. In the receiver, this heat is transferred to the liquid salt heat transfer medium, i.e. the nitrate salt melt, and then temporarily stored in a hot tank. Hot salt, i.e. hot molten nitrate salt, can be continuously removed from this hot tank with a pump and made available to the power plant block for further electric power production. The nitrate salt melt cooled down by this process is then temporarily stored in a cold tank, from where it can be made available to the receiver again when the sun is shining.

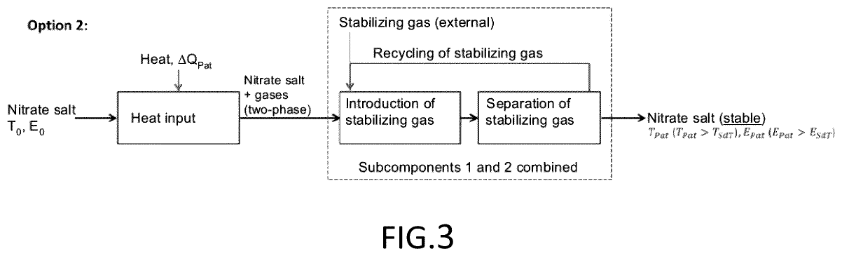

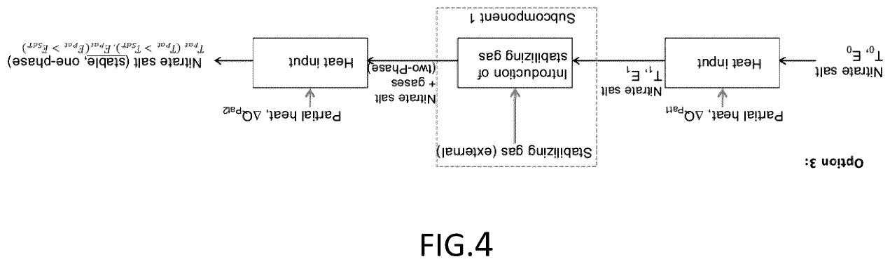

This set-up is now modified by the present invention by the first and second subcomponents. These are built into this per se known set-up of a solar receiver to obtain a device according to the invention. In this case, it is possible for the first and possibly the second subcomponent to be provided at different positions. These two embodiments are shown in FIGS. 2 and 3. FIG. 4 shows an embodiment in which there is no second subcomponent.

In an embodiment of a device according to the invention, which is shown schematically in FIG. 2, the first and second subcomponents are realized with an intermediate process, namely the introduction of heat. The heat input may take place, for example, by a solar receiver or the heat absorbed thereby. In this embodiment, the nitrate salt melt is brought into contact with the stabilizing gas at a lower temperature before the heat is introduced. The thus produced mixture of molten nitrate salt and stabilizing gas is then forwarded to a receiving unit, in which the heat is introduced. The nitrate salt melt, which contains dissolved gases and above which there is also a gas phase with the stabilizing gas, is less sensitive to material decomposition than the pure nitrate salt melt. Subsequent to the heat input and any other components present in the reactor that cause strong fluid movement, the stabilizing gas is separated in the second subcomponent and returned to the first subcomponent.

An alternative embodiment of the device according to the invention is shown in sections in FIG. 3. In this, the first and second subcomponents are combined. First, the heat is introduced, which causes the molten salt to decompose. Following the heat input, the stabilizing gas is introduced into the nitrate salt melt in the first subcomponent. A regeneration of the salt takes place for a certain duration of flow of the nitrate salt melt in the device up to the zone of the second subcomponent, in which the separation of the gas from the melt takes place.

After the second subcomponent, a stabilized nitrate salt is obtained, which can be further used in a solar power plant. Overall, the method according to the invention and the device according to the invention reduce the formation of toxic gases, which can escape into the environment as exhaust gas, for example. Furthermore, the corrosiveness of the melt is reduced, so that the service life of the power plants or the individual components can be significantly extended, which means that economically efficient operation is possible.

In a preferred embodiment, the first subcomponent can have an active gas transport with compressors. In a preferred embodiment, this can also have a nozzle injection system that enables the stabilization gas to be sprayed through nozzles into the nitrate salt melt. Passive gas transport by means of a liquid jet vacuum pump is also conceivable, with the pumping power coming from the kinetic energy of the nitrate salt melt.

The surface area between the nitrate salt melt and the stabilizing gas can also be increased, for example, by means of a stirrer, a static mixer or a ceramic membrane disk. Increasing the interface area improves the gas input into the nitrate salt melt and thus improves stabilization.

In order to increase the residence time of the nitrate salt melt in the first subcomponent, the latter may also have active or passive circulation for the nitrate salt melt. Active recirculation can be enabled, for example, by means of a centrifugal pump, a passive one by means of a liquid jet liquid pump, to name just one example each.

In a preferred embodiment, the second subcomponent has a cyclone for gas separation. However, it is also possible for the gas to be separated in the zone of the second subcomponent solely by gravity.

To increase the residence time, the second subcomponent may also have devices for recirculation in the nitrate salt melt. Here, too, active or passive pumps, such as a centrifugal pump for active recirculation or a liquid jet liquid pump for passive circulation, can be provided.

The second subcomponent preferably also includes connection conduits for the pressure, fill level and gas atmosphere settings in the separation container in which the separated stabilization gas is collected.

FIG. 4 shows an embodiment in which the amount of heat is not supplied completely, but divided into two partial amounts of heat ΔQₚₐₜ₁ and ΔQₚₐₜ₂. A first subcomponent, through which the stabilizing gas is supplied, is located between these two points. First of all, a two-phase flow also occurs in this embodiment. However, the supply of the amount of heat ΔQₚₐₜ₂ increases the gas solubility in the nitrate salt melt, so that there is only one phase after the supply of the second partial amount of heat ΔQₚₐₜ₂. A second subcomponent is dispensable here.

1. A method for the thermal stabilization of nitrate salt melts in thermal power plants, comprising:
a) providing a nitrate salt melt, the nitrate salt selected from alkali metal nitrates, alkaline earth metal nitrates or mixtures of one or more alkali metal nitrates and alkaline earth metal nitrates, and transporting the nitrate salt melt in conduits,
b) introducing a quantity of heat (ΔQₚₐₜ) to the nitrate salt melt at a defined position, the quantity of heat being provided in particular by means of solar energy,
wherein a stabilizing gas is fed to the nitrate salt melt before or after step b), the stabilizing gas comprising oxygen, at least one nitrogen oxide and optionally nitrogen.

2. The method according to claim 1, further comprising the quantity of heat is introduced in the form of two, three or more partial quantities of heat (ΔQₚₐₜ₁, ΔQₚₐₜ₂, Qₚₐₜ₃).

3. The method according to claim 1, further comprising the stabilizing gas contains one or more nitrogen oxides selected from NO, NO₂ and N₂O.

4. The method according to claim 1, wherein the stabilizing gas is at least partially separated from the nitrate salt melt.

5. The method according to claim 1 wherein the stabilizing gas is provided by means of an external source.

6. The method according to claim 1, wherein the stabilizing gas is added to the solar salt melt at a pressure of 1 bar or more.

7. The method according to claim 1, wherein the stabilizing gas contains 20% by volume or more oxygen and 500 ppm or more nitrogen oxides, and optionally nitrogen.

8. The method according to claim 4, wherein the separation of the gas from the nitrate salt melt takes place due to gravity or by means of a cyclone.

9. A device for carrying out a method according to claim 1, comprising:
a) at least one receiving unit for receiving thermal energy from solar radiation,
b) at least one first storage unit in which a nitrate salt melt can be stored after it has absorbed thermal energy from the receiving unit,
c) at least one consumer in which the thermal energy from the nitrate salt melt is converted to electric power,
d) at least one second storage unit in which the nitrate salt melt can be stored after the thermal energy has been converted to electric power, and
d) conduits in which a nitrate salt melt is circulated,
wherein the device further
e) has at least one first subcomponent, in which a stabilizing gas is fed to the nitrate salt melt,
wherein the at least one first subcomponent is provided upstream or downstream of the at least one receiving unit for receiving thermal energy in the direction of flow of the nitrate salt melt.

10. The device according to claim 9, further comprising:
f) at least one second subcomponent, in which the stabilizing gas is removed from the nitrate salt melt,
wherein
the at least one second subcomponent is provided downstream of the first subcomponent and downstream of the receiving unit for receiving thermal energy in the direction of flow of the nitrate salt melt.

11. The device according to claim 9, wherein the first subcomponent has a device for introducing the stabilizing gas.

12. The device according to claim 9, wherein the second subcomponent has a device for gas separation.

13. The device according to claim 9, wherein the at least one first and/or the at least one second subcomponent has a device for active or passive recirculation in order to increase the residence time of the nitrate salt melt in the respective subcomponent.
